(19) United States
(12) Patent Application Publication
(10) Pub. No.: US 2003/0146852 A1
(43) Pub. Date: Aug. 7, 2003

(54) Coinless parking administration apparatus, system, and method

(76) Inventor: Robert B. O'Dell, Oakland, CA (US)

Correspondence Address: LAW OFFICES OF JAMES D. IVEY, 3025 Totterdell Street, Oakland, CA, 94611-1742, US

(21) Appl. No.: 10/068,808

(22) Filed: Feb. 4, 2002

(51) Int. Cl. G08B 1/08; H04Q 7/00

(52) U.S. Cl. 340/932.2; 340/5.2; 340/309.16

(57) ABSTRACT

A wireless transceiver is used by a person wishing to park a vehicle to (i) request parking authorization wherein the request includes a parking start time and, (ii) when leaving the parking location, request termination of parking authorization at a parking end time. The transceiver communicates wirelessly with a parking server which notes the parking start and end times to determine a parking duration and a parking fee determined according to the parking duration. The parking fee can also be determined according to other factors such as day of week, time of day, holiday status, location, and one or more characteristics of the user.

### FIELD OF THE INVENTION

This invention relates to the field of parking payment systems and, more specifically, to an electronic device enabling coinless parking payment and a system and method involving such a device.

### BACKGROUND OF THE INVENTION

Current parking administration systems are costly and cumbersome for parking provider and customers alike. Current systems are predominantly cash-based and require that users carry coins in sufficient number and denominations to accommodate potential parking needs. Some parking administration systems use expensive payment machines which accept and verify paper money. However, such machines are a source of considerable frustration for users since such machines frequently reject worn but otherwise legitimate bills.

For parking providers, cash-based systems are expensive in that cash-accepting machines must be deployed at parking locations distributed about a city or region and that personnel must be hired to collect cash deposited in such machines. Cash-accepting machines must generally be made highly secure to thwart even mere attempts at vandalism and theft and to protect collected revenue from even those personnel hired to collect the revenue from the machines. Such machine must also be maintained and perhaps replaced periodically - all at various remote locations throughout the region maintained by the parking provider. Inoperative machines can result in significant revenue loss as failure of the cash-accepting machine can result in the inability to collect fees for parking.

In addition, parking according to currently popular administrative systems requires the user to predict a duration of parking needed. Over-estimating parking duration can result in overpayment for parking used since payment is general up front, i.e., before parking space is used. Under-estimating parking duration can result in steep fines. Such fines are generally steep to cover costs of parking enforcement and customer grievance procedures including litigation. Many perceive such administrative costs to be waste and excess, particularly in relation to the relative simple need to stop one's vehicle and exit to conduct business within a particular city's borders.

Accordingly, a more convenient and efficient mechanism for purchasing parking time is needed.

### SUMMARY OF THE INVENTION

In accordance with the present invention, a wireless transceiver is used by a person wishing to park a vehicle to (i) request parking authorization wherein the request includes a parking start time and, (ii) when leaving the parking location, request termination of parking authorization at a parking end time. The transceiver communicates wirelessly with a parking server which notes the parking start and end times to determine a parking duration and a parking fee determined according to the parking duration. The parking fee can also be determined according to other factors such as day of week, time of day, holiday status, location, and one or more characteristics of the user.

The user requests parking authorization by merely pressing a single button on the wireless transceiver. The transceiver determines its location and sends a request which includes the location, current time, identification of the transceiver, the vehicle in which the transceiver is installed, and the user. This information is recorded by the parking server and is made available to parking enforcement personnel at least to the extent necessary for parking enforcement personnel to readily determine that the vehicle is legitimately parked. When the user has concluded activities in the area and wishes to vacate the parking location, the user presses another button and transceiver sends the same information to the parking server to thereby terminate authorization for parking and to indicate the duration for which the vehicle was parked.

Thus user is assisted in that the transceiver detects opening and closing of the ignition switch of the vehicle to detect potential parking events such as arrival at or departure from a parking location. Such events trigger attention-getting actions such as tones, voice prompts, and/or flashing lights.

### BRIEF DESCRIPTION OF THE DRAWINGS

FIG. 1 is a diagrammatic illustration of a parking administration system in accordance with the present invention.

FIG. 2 is a block diagram of the parking administration system of FIG. 1.

FIG. 3 is a block diagram of the remote parking manager of FIG. 2 in greater detail.

FIG. 4 is a block diagram of the parking server of FIG. 2 in greater detail.

FIG. 5 is a block diagram of the parking management database of FIG. 4 in greater detail.

FIG. 6 is a logic flow diagram of initialization and operation of the remote parking manager of FIG. 3 in accordance with the present invention.

FIG. 7 is a logic flow diagram of the interaction between the remote parking manager and the parking server in an arrival phase in accordance with the present invention.

FIG. 8 is a logic flow diagram of the interaction between the remote parking manager and the parking server in a departure phase in accordance with the present invention.

FIG. 9 is a logic flow diagram of the interaction between the remote parking manager and the parking server in rate request phase in accordance with the present invention.

### DETAILED DESCRIPTION

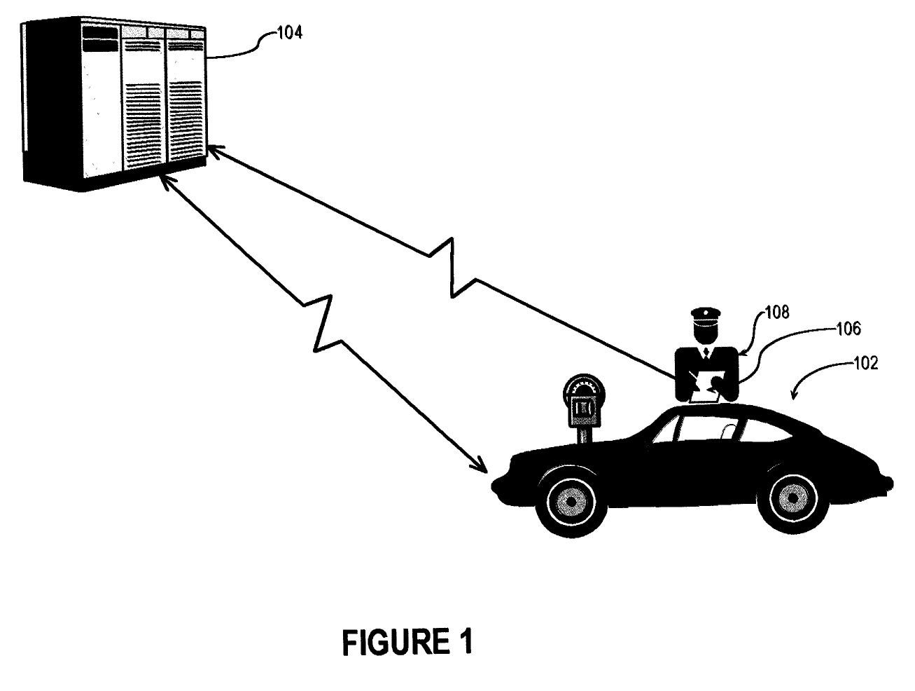

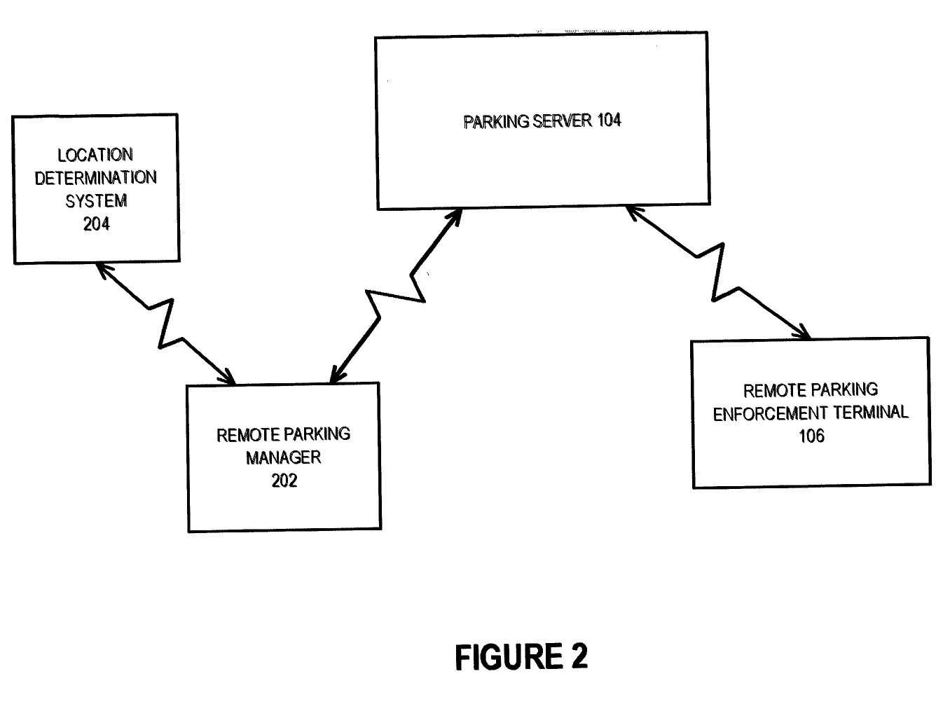

In accordance with the present invention, a person parking a car 102 (FIG. 1) uses a wireless link to a parking server 104 which tracks usage and payment of parking and transmits such usage information to a remote parking enforcement terminal 106 used by parking enforcement personnel 108. The parking system of FIG. 1 is shown in block diagram form in FIG. 2.

Car 102 (FIG. 1) includes a remote parking manager 202 (FIG. 2) which can communicate with parking server 104 and a location determination system 204. Location determination system 204 is described more completely below. Parking server 104 can also communication with remote parking enforcement terminal 106.

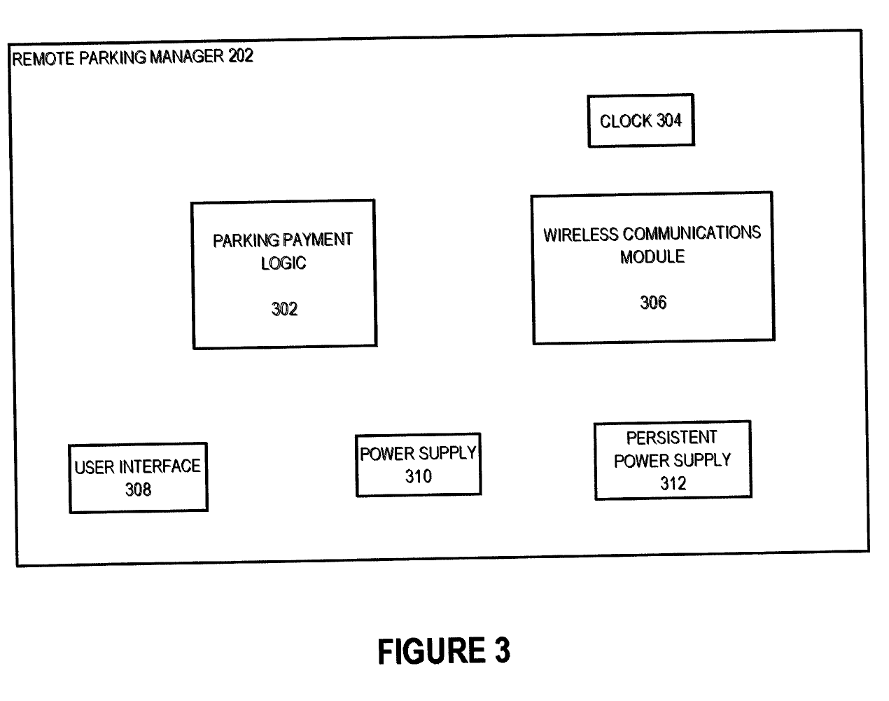

Remote parking manager 202 is shown in greater detail in FIG. 3. Remote parking manager 202 includes parking payment logic 302 which controls the behavior of remote parking manager 202. Parking payment logic 302 can include circuitry logic and/or a general purpose computer processor and associated computer instructions and data stored in memory to cause the behavior described herein. Remote parking manager 202 also includes a clock 304 which is used by parking payment logic 302 to record parking activity in the manner described below. In an alternative embodiment, clock 304 can be omitted as parking payment logic 302 obtains time information through either location determination or wireless communication with parking server 104 as described more completely below.

Wireless communications module 306 conducts wireless communications with location determination system 204 (FIG. 2) and parking server 104. Such wireless communications is described more completely below.

User interface 308 provides an interface by which the subject user, i.e., the user of remote parking manager 202, authorizes payment for parking, terminates payment for parking, and obtains parking information. User interface 308 can fall nearly anywhere along a continuum between quite simple such as three (3) buttons associated with respective textual function descriptions on one hand and, on the other hand, quite sophisticated such as a voice interface involving audio voice prompts and speech recognition. Of course, somewhere along that continuum is a simple LCD display with conventional user input devices.

Remote parking manager 202 also includes a power supply 310 and a persistent power supply 312. Power supply 310 is coupled to power in car 102 (FIG. 1) primarily to enable detection of power to ignition in car 102 and secondarily to provide power to remote parking manager 202 and to charge persistent power supply 312. Persistent power supply 312 provides power to remote parking manager 202 when power is not received by power supply 310 from car 102. In one embodiment, persistent power supply 312 is a rechargeable battery with charging circuitry coupled to power supply 310. In an alternative embodiment, power supply 310 is coupled to the power supply of car 102 through an ignition switch and persistent power supply 312 is coupled to the power supply of car 102, bypassing the ignition switch such that remote parking manager 202 receives power notwithstanding cut-off of the ignition switch of car 102 (FIG. 1).

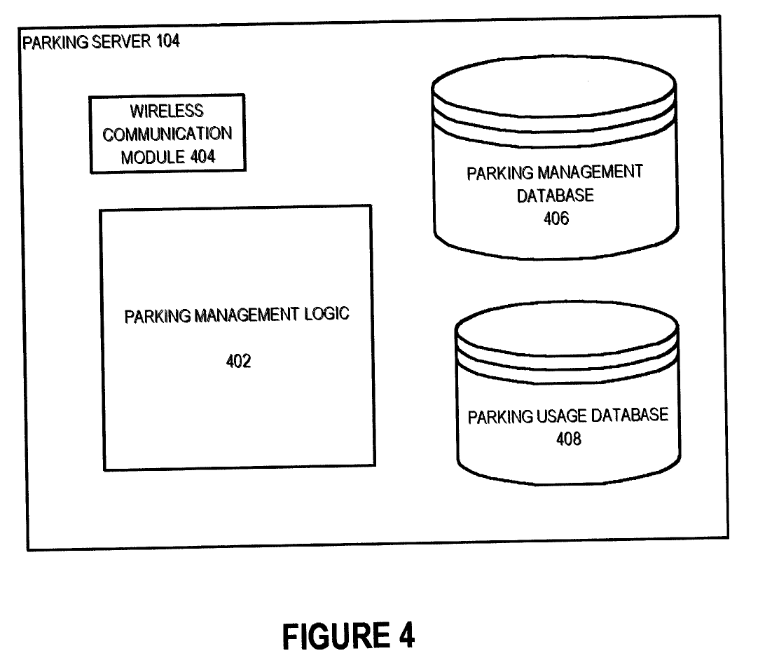

Parking server 104 is shown in greater detail in FIG. 4. Wireless communication module 404 can communicate wirelessly with wireless communication module 306 (FIG. 3) of remote parking manager 202 and with remote parking enforcement terminal 106 (FIG. 2).

Parking management logic 402 controls the behavior of parking server 104. Parking management logic 402 can include circuitry logic and/or a general purpose computer processor and associated computer instructions and data stored in memory to cause the behavior described herein.

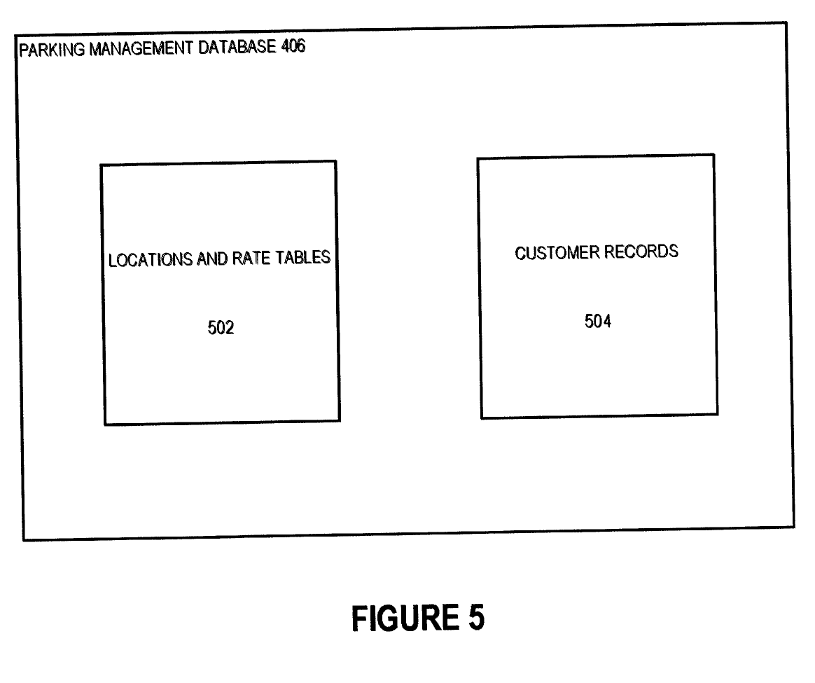

Parking management database 406 stores data specifying information pertaining to all parking resources managed by parking server 104 and is shown in greater detail in FIG. 5. Locations and rates tables 502 specifies parking rates at various parking locations under management by parking server 104. Customer records 504 includes data describing various customers who can manage parking through use of parking server 104.

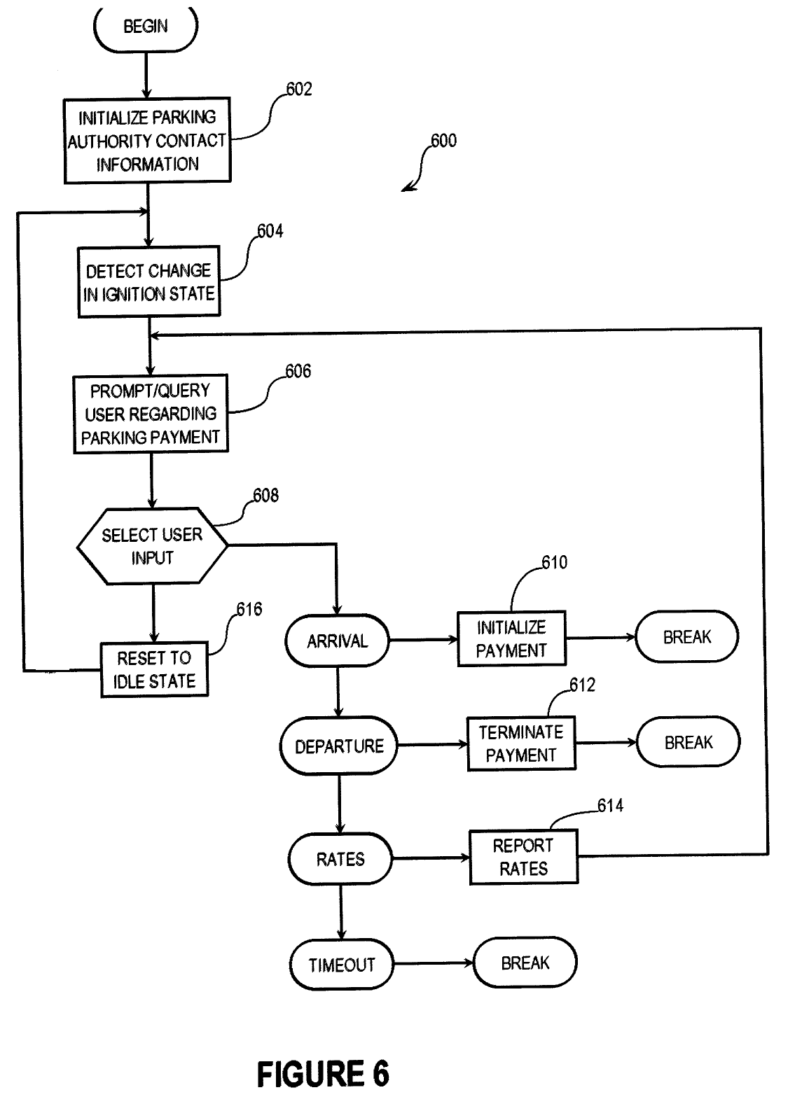

Logic flow diagram 600 (FIG. 6) illustrates operation of remote parking manager 202. Upon power-up, remote parking manager 202 initializes parking authority contact information in step 602. Such contact information depends on the particular communications protocol uses by wireless communications modules 306 and 404. If such communications protocol is a wireless telephone connection, such contact information includes a telephone number by which remote parking manager 202 can contact parking server 104. If such communications protocol is a short messaging server (SMS), such contact information includes an SMS address or an e-mail address for SMS message delivery.

Such contact information can be initialized in a number of ways. A simple, but not particularly convenient initialization is manual entry by the user through user interface 308. An alternative initialization mechanism includes determining a location of remote parking manager 202 in the manner described below and communicating such location to parking server 104 or a regional parking server through wireless communication module 306 to thereby obtain such contact information according to the determined location of remote parking manager 202. In a third, perhaps best embodiment, parking payment logic 302 first attempts communication using stored contact information from any previous communication with parking server 104 and, upon failure, obtains new contact information by reference to a regional parking server as described above.

In step 604 (FIG. 6), parking payment logic 302 (FIG. 3) detects a change in the ignition state of car 102, such as the cutting off of the ignition switch or the closing of the ignition switch, to detect a possible parking event. Such is determined by noting cessation or introduction of power to power supply 310 while persistent power supply 312 enables continued operation of remote parking manager 202.

In step 606 (FIG. 6), parking payment logic 302 (FIG. 3) uses user interface 308 to prompt the user to specify whether parking is to be paid for at this moment. Such prompt can be textual, audio, graphical, etc. However, it should be noted that the user's attention may be directed elsewhere and some form of attention acquisition should be employed.

In select step 608 (FIG. 6), parking payment logic 302 (FIG. 3) determines what action, if any, the user has specified through user interface 308. In this illustrative example, user interface 308 include three (3) buttons respectively labeled “Park,” “Leave Parking,” and “Rates.”

If the user presses the “Park” button, parking payment logic 302 initializes payment for parking in step 610. If the user presses the “Leave Parking” button, parking payment logic 302 terminates payments for parking in step 612. If the user presses the “Rates” button, parking payment logic 302 retrieves and reports parking rates for the current location of remote parking manager 202 in step 614. If the user takes no action for a predetermined period of time, parking payment logic 302 takes no action. After any of the actions of steps 610-612 or user input timeout, processing transfers to step 604 in which parking payment logic 302 detects a change in the ignition state of car 102 in the manner described above. After step 614, processing transfers to step 606 in which the user is prompted again regarding which action to take with respect to parking payment.

Thus, the basic use of remote parking manager 202 is as follows. When car 102 is parked, parking payment logic 302 detects the potential parking event in the form of opening of the ignition switch. The user is prompted to take action in response to the parking event. If the user takes no action, nothing else happens until the next potential parking event. If the user wants rate information, the user presses the “Rates” button and is presented with rate information at the determined location of remote parking manager 202. After presentation of the rate information, the user is again prompted since the parking event has not been responded to.

At the prompt the user can do nothing to not pay for parking or presses the “Park” button to initiate payment for parking. The user is thereafter free to leave car 102 in its place and conduct whatever business the user has near that parking location. For reasons described more completely below, the user need not worry about what approximate time the user might return to car 102. When ready to leave, the user enters car 102 and closes the ignition switch to power-up and start car 102. Such is detected by parking payment logic 302 of remote parking manager 202 as a potential parking event and prompts the user for action. In this illustrative embodiment, parking payment logic 302 deactivates the “Park” button since parking payment is already in progress. Deactivation of a button can be communicated to the user by de-illumination of the deactivated button, for example. Continuing in the illustrative usage example, the user presses the “Leave Parking” button to deactivate payment for parking.

Therefore, the user is no longer required to collect and maintain a stash of coins to pay for parking. In inclement weather, fumbling to put coins in a parking meter is particular frustrating and annoying. In accordance with the present invention, the user can simply press a button from the comfort of the interior of a car and can subsequently terminate parking payment also from the comfort of the interior of the car.

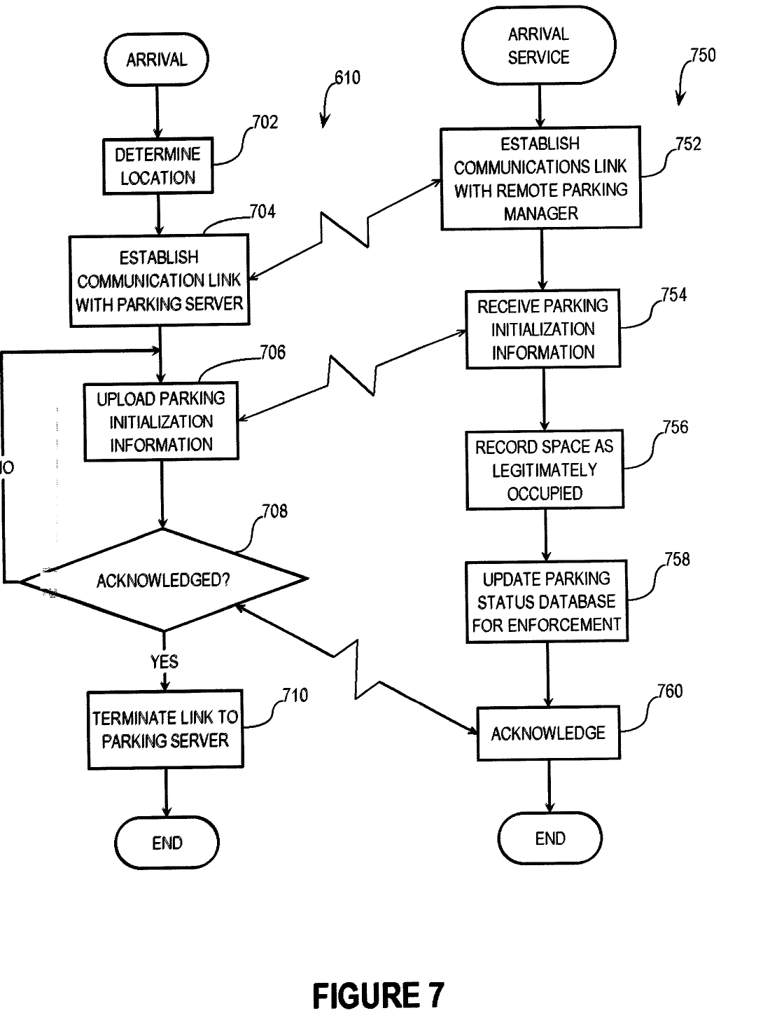

Step 610 in which parking payment logic 302 of remote parking manager 202 initiates payment for parking is shown in greater detail as logic flow diagram 610 (FIG. 7). In step 702, parking payment logic 302 (FIG. 3) determines a location of remote parking manager 202. Such location determination can be accomplished in any of a number of conventional manners including, for example, global positioning satellite (GPS) systems and estimated observed time difference (EOTD) systems. The latter systems are used by mobile telephone system providers for location of mobile telephones in emergency situations. Such EOTD systems are also available for non-emergency use such as location determination for remote parking manager 202. In an alternative embodiment, each parking space has a radio frequency identification device (RFID). Such devices are known and conventional and are therefore not described herein. It is preferred that such RFIDs have a range of at least 5-10 feet. These RFIDs can be placed on each existing parking meter or otherwise adjacent to one or more parking spaces. In this alternative embodiment, remote parking manager 202 determines its location by retrieving the identifier of the nearest parking space; the identifier specifies a location with sufficient specificity for the purposes of parking server 104.

In step 704 (FIG. 7), parking payment logic 302 (FIG. 3) establishes a wireless communications link with parking server 104. Various communications links can be used including, for example, a wireless telephone link, a wireless connection to the Internet, or a wireless channel for SMS messages. The parking server 104 cooperates in step 754 to the extent necessary to establish the wireless communications link.

In step 706 (FIG. 7), parking payment logic 302 (FIG. 3) uploads parking initialization information. Such information includes, for example, data specifying that parking is to begin, the current time as determined from clock 304 or through some location determining system such as GPS or EOTD, the location determined in step 702, and identification data such as a subscriber identification data (SID) and/or a license plate number of car 102. In this illustrative embodiment, no parking initialization data must be entered by the user at the time parking payment is initiated.

In step 754 (FIG. 7), parking management logic 402 receives the parking initializing data. In step 756, parking server 104 records the space identified in the parking initializing data as legitimately occupied and/or the car identified in the parking initialization data as legitimately parked in parking usage database 408. In this illustrative embodiment, parking server 104 first establishes that the user identified by the SID in the parking initialization data is a valid user of parking services provided through parking server 104 and has sufficient funds in an associated debit account to pay for at least a predetermined period of time at the determined location and has not outstanding parking citations.

In step 758, parking management logic 402 updates parking status as reported to parking enforcement personnel to indicate that car 102 is legitimately parked. In an alternative embodiment, such status is generated from parking usage database 408 upon request by remote parking enforcement terminal 106 in a manner described more completely below. This alternative embodiment therefore skips step 758.

In step 760, parking management logic 402 acknowledges successful receipt and acceptance of the parking initialization data sent in step 704.

In step 708, parking payment logic 302 waits a predetermined amount of time to receive acknowledgment from parking server 104. If no acknowledgment is received, step 706 is repeated. If acknowledgment is received, parking payment logic 302 terminates the wireless communications link in step 710.

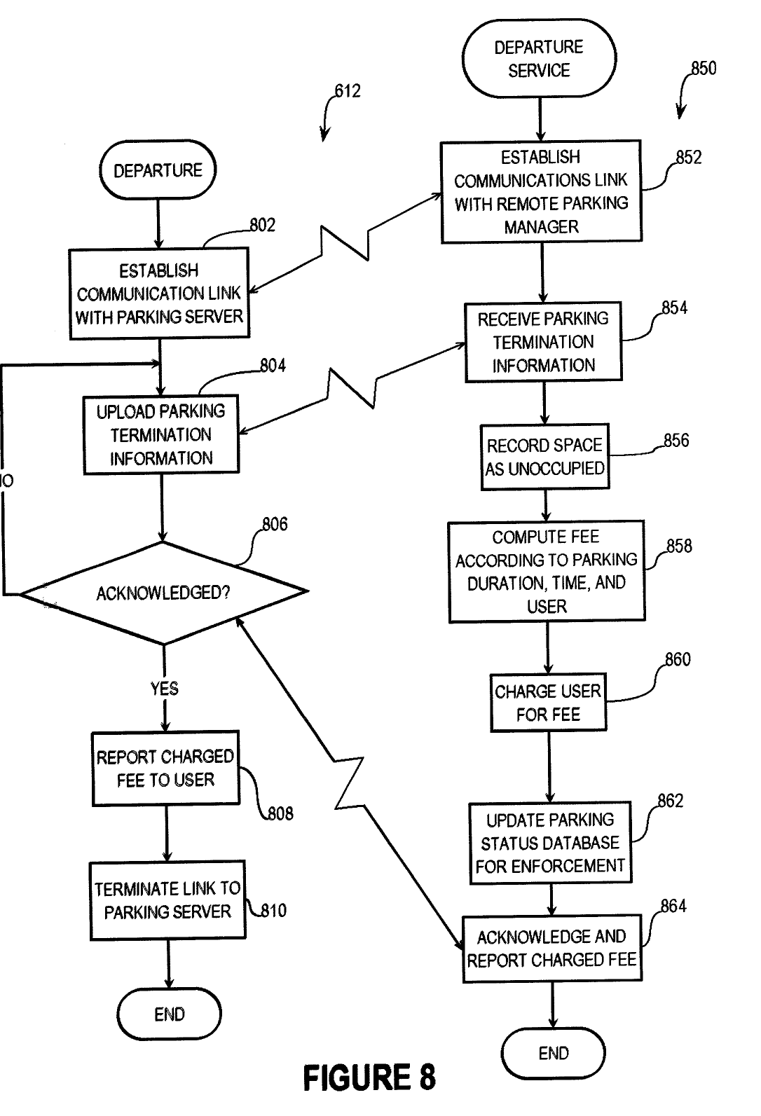

Step 612 in which parking payment logic 302 of remote parking manager 202 terminates payment for parking is shown in greater detail as logic flow diagram 612 (FIG. 8). In step 802, parking payment logic 302 (FIG. 3) establishes a wireless communications link with parking server 104 in the manner described above with respect to step 704.

In step 804 (FIG. 8), parking payment logic 302 (FIG. 3) uploads parking termination information. Such information includes, for example, generally the same data sent in step 706 (FIG. 7) except that data specifying that parking is to begin is replaced with data specifying that parking is terminated. In an alternative embodiment, data indicating whether parking is beginning or ending is not included and such parking information toggles between a state in which parking is active and a state in which parking is inactive. However, it is preferred that the parking information be unambiguous with respect to the desired parking state.

In step 854 (FIG. 8), parking server 104 receives the parking terminating data. In step 856, parking server 104 records the space identified in the parking initializing data as unoccupied and/or the car identified in the parking initialization data as not legitimately parked in parking usage database 408. In this illustrative embodiment, parking server 104 first establishes that the user identified by the SID in the parking initialization data is a valid user of parking services provided through parking server 104 and that the identified parking space was previously recorded as occupied and/or that the identified car was previously recorded as legitimately parked.

In step 858, parking management logic 402 determines the fee for parking as reported by remote parking manager 202. The fee can be generally based on any formula from one as simple as a flat rate to one based on a complex formula involving—among other factors—the duration for which car 102 was parked, the particular space or area in which car 102 was parked, the time of day, the day of the week, holiday status, a particular rate plan associated with the user, and current parking usage for a particular region. To determine the fee, parking management logic 402 can use locations and rate tables 502 and/or customer records 504.

In step 860 (FIG. 8), parking management logic 402 (FIG. 4) charges the user the fee determined in step 858. The fee can be charged in a number of ways. For example, a debit account can be associated with the user and represented in customer records 504. The fee can be charged by deducting the fee from the debit account. To preserve coinless parking privileges, the user would periodically replenish the debit account. Parking server 104 can report the debit account balance to the user in a period statement mailed to the user and/or in acknowledgments sent in steps 760, 864, and 958. Any balance information in such acknowledgments can be presented to the user through user interface 308 (FIG. 3) by parking payment logic 302.

The fee can also be charged by accumulating accrued charges and sending a periodic bill for subsequent payment. Alternatively, the fee can be charged by applying the fee to a credit account or a wireless communications service account associated with the user within customer records 504.

In step 862 (FIG. 8), parking management logic 402 updates parking status as reported to parking enforcement personnel to remove any indication that car 102 is legitimately parked. In an alternative embodiment, such status is generated from parking usage database 408 upon request by remote parking enforcement terminal 106 in a manner described above with respect to step 758 and more completely below. This alternative embodiment therefore skips step 862 (FIG. 8).

In step 864, parking management logic 402 acknowledges successful receipt and acceptance of the parking initialization data sent in step 804.

In step 806, parking payment logic 302 waits a predetermined amount of time to receive acknowledgment from parking server 104. If no acknowledgment is received, step 804 is repeated. If acknowledgment is received, parking payment logic 302 reports the charged amount to the user in step 808. For example, the amount can be represented in a display of user interface 308 of remote parking manager 202 or can be reported by synthesized voice.

In step 810, parking payment logic 302 terminates the wireless communications link with parking server 104.

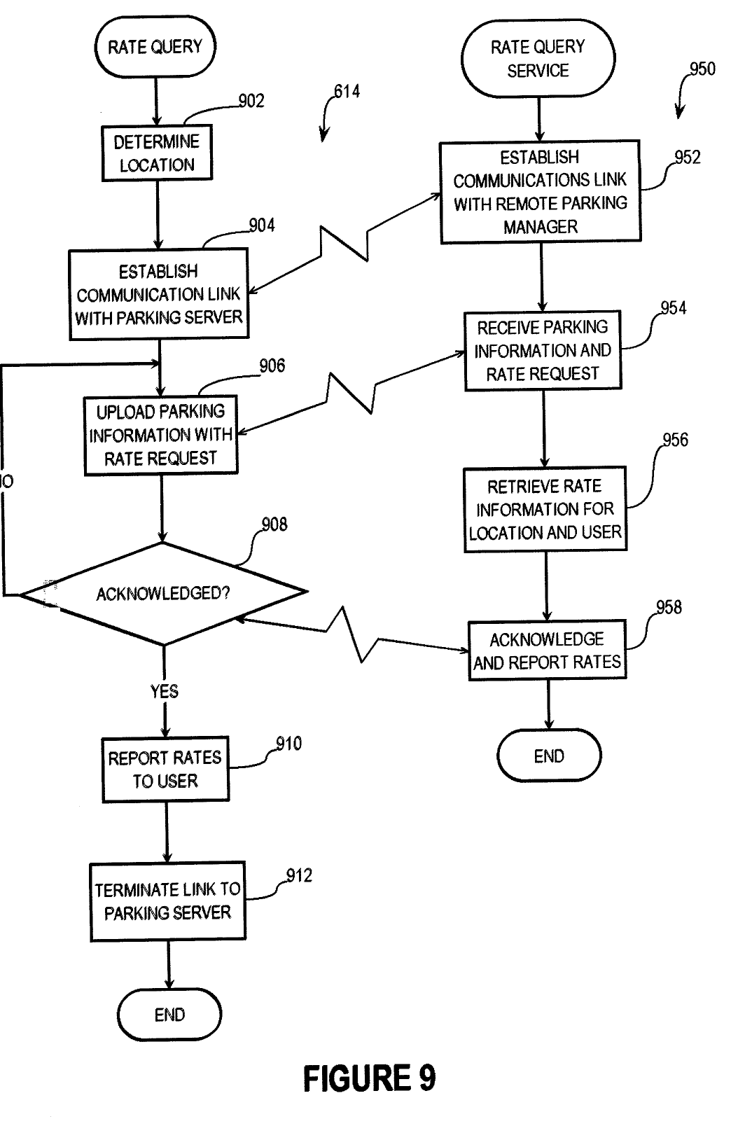

Step 614 in which parking payment logic 302 of remote parking manager 202 requests parking rates is shown in greater detail as logic flow diagram 614 (FIG. 9). In step 902, parking payment logic 302 (FIG. 3) determines a location of remote parking manager 202 in the manner described above with respect to step 702 (FIG. 7). In step 904 (FIG. 9), parking payment logic 302 (FIG. 3) establishes a wireless communications link with parking server 104 in the manner described above with respect to step 704 (FIG. 7).

In step 906 (FIG. 9), parking payment logic 302 (FIG. 3) uploads a rate request. The rate request includes, for example, generally the same data sent in step 706 (FIG. 7) except that data specifying that parking is to begin is replaced with data indicating a rate request. Information identifying the current time, the location of remote parking manager 202, the user, etc. are useful in determining applicable rates since parking rates can be dependent upon such factors as described above.

In step 954 (FIG. 9), parking server 104 receives the parking terminating data.

In step 956, parking management logic 402 (FIG. 4) determines a schedule of rates for the location, user, and time indicated in the rate request. To the extent other factors are used in calculating fees, those factors are taken into consideration in determining the fee schedule such that the fee schedule accurately represents relevant information to the user. The schedule includes sufficient information that the user is fully apprised of the rate to be paid. For example, if the parking rate is a flat rate regardless of time or flat rate with a maximum duration, the fee schedule so indicates. Similarly, if the parking rate is a fixed fee for a first duration, changes to a per 15-minute period charge for a second duration, and increases to a per minute charge for a third duration; such information is completely and accurately represented in the fee schedule.

In step 958 (FIG. 9), parking management logic 402 acknowledges receipt of the rate request and sends the fee schedule to remote parking manager 202.

In step 908, parking payment logic 302 waits a predetermined amount of time to receive acknowledgment from parking server 104. If no acknowledgment is received, step 906 is repeated. If acknowledgment is received, parking payment logic 302 reports the fee schedule to the user in step 910. For example, the fee schedule can be represented in a display of user interface 308 of remote parking manager 202 or can be reported by synthesized voice. In one embodiment, payment management logic 402 sends the fee schedule to remote parking manager 202 in a verbal form ready for visual display and/or auditory presentation to the user by user interface 308. In an alternative embodiment, parking payment logic 302 converts the fee schedule to a verbal form suitable for presentation to the user.

In step 912, parking payment logic 302 terminates the wireless communications link with parking server 104.

Parking Enforcement

Parking enforcement of parking managed in the manner described above relies on getting current parking status information to parking enforcement personnel 108. In particular, current and accurate parking information is made available to parking enforcement personnel 108 through remote parking enforcement terminal 106.

In this illustrative embodiment, remote parking enforcement terminal 106 is a portable computer with the capability of accessing the World Wide Web through a wireless Internet connection. Examples include notebook computers, pen-based palmtop computers, and personal digital assistants (PDAs). In this illustrative embodiment, parking management logic 402 (FIG. 4) includes a web server which sends current and accurate parking information to requesting personnel. In particular, remote parking enforcement terminal 106 sends a request for parking information in the form of a URL (universal resource locator) which includes data specifying a location of remote parking enforcement terminal 106. The location can be determined in the manner described above with respect to remote parking manager 202 or can be simply fixed, predetermined data specifying a zone of responsibility for parking enforcement personnel 108.

The web server of parking management logic 402 responds to the request by retrieving data from parking usage database 408 pertaining to parking locations in the general area of the location of remote parking enforcement terminal 106. The resulting list of legitimately occupied parking spaces and/or legitimately parked vehicles can viewed and rearranged by parking enforcement personnel 108 using conventional user interface techniques. Such techniques can include, for example, clicking on a column of parking locations to sort the parking information by parking location and/or clicking on a column of vehicle license plate numbers to sort the parking information by vehicle license plate numbers.

Thus, parking enforcement personnel 108 can determine that a car is illegitimately parked if (i) a meter at the parking location is expired and (ii) remote parking enforcement terminal 106 does not indicate that the parking location is legitimately occupied.

Fixed Parking Term Embodiment

In an alternative embodiment, parking is reserved for a user-specified amount of time after which parking is no longer authorized and a citation can be issued by parking enforcement personnel 108. Thus, the parking fee model in this embodiment is more analogous to the manner in which currently used parking meters work. In this alternative embodiment, the user specifies an amount of time when initiating parking payment and the requested amount of time is included in the parking initialization information sent in step 706 (FIG. 7). The fee for parking the requested amount of time is charged to the user immediately rather than upon departure from the parking location. In addition, since expiration time is known by parking management logic 402 (FIG. 4), expiration time of parking payment can be included in the display of remote parking enforcement terminal 106. Accordingly, parking enforcement personnel 108 can request that local parking information is sorted by expiration time to therefore efficiently police parking by looking specifically for vehicles whose parking authorization is about to expire.

Remote parking manager 202 and/or parking server 104 can be configured to warn users as parking authorization is about to expire. Remote parking manager 202 can include data specifying a mobile telephone or pager or similar portable communications device by which the user can be warned a few minutes prior to expiration of parking. Similarly, customer records 504 can include such contact information and warning preferences of the user. Upon warning of imminent parking expiration, the user can be presented with an opportunity to respond to the warning with a request to extent parking authorization.

In the embodiment in which remote parking manager 202 sends the warning to the user, remote parking manager 202 can also receive a message from the user, e.g., by SMS message, to extend parking authorization by an amount specified in the message or by a previously specified parking authorization increment. Similarly, in the embodiment in which parking server 104 sends the warning to the user, parking server 104 can also receive a message from the user. This message can also specify an amount of time by which to extend parking authorization or parking authorization can be extended by a previously specified parking authorization increment associated with the user in customer records 504.

Packaging Considerations

In the embodiment described herein, remote parking manager 202 is mounted inside—and connected to the power supply of—car 102 in a permanent or semi-permanent installation.

Such enables remote parking manager 202 to detect opening and closing of the ignition switch of car 102 to automatically detect potential parking events and to be conveniently powered by car 102. Remote parking manager 202 can use other systems of car 102 to effect the behavior described above. For example, remote parking manager 202 can use an onboard road assistance wireless communication system to communicate with parking server 104 and can use an onboard GPS navigation system to self location as described above with respect to steps 702 (FIG. 7) and 902 (FIG. 9). Similarly, remote parking manager 202 can use existing voice/auditory/visual warning systems to warn of possible unauthorized parking or failure to terminate parking after leaving a parking location.

Such a remote parking manager 202 can be readily integrate into vehicles during manufacture. Retrofitting existing vehicles can be accomplished by packaging remote parking manager 202 into a small box that can be clipped to a sun visor or placed on the dashboard of a vehicle. Remote parking manager 202 can also be implemented in a handheld mobile telephone; however, such requires care that remote parking manager 202 has proper vehicle identification information to the extent such information is desired by parking server 104. Moreover, care should be taken to properly identify the location for which parking is to be authorized. Consider an example in which the user has walked away from car 102 prior to authorizing parking and, as an afterthought, authorizes parking remotely from car 102. If remote parking manager 202 determines location according to the nearest parking meter RFID in the manner described above, it is possible that parking is authorized for a parking location other than the location in which car 102 is parked. In addition, it is preferred that voice communication through a mobile telephone by the user does not interfere with proper functioning of the parking authorization system described herein. However, despite these concerns, implementation of remote parking manager 202 in a portable device such as a mobile telephone, 2-way pager, or Internet capable PDA has many of the advantages described above.

The above description is illustrative only and is not limiting. Instead, this description is merely illustrative, and the present invention is defined solely by the claims which follow and their full range of equivalents.

What is claimed is:

1. A device for authorizing parking of a vehicle at a parking location, the device comprising:
logic which is configured to authorization parking by:
sending a parking authorization request to a parking server wherein the parking authorization request identifies the vehicle and the parking location and starting time of authorized parking; and
sending a parking termination request to the parking server wherein the parking termination request identifies an ending time of authorized parking.

2. A method for administering parking, the method comprising:
receiving a parking authorization request which includes a parking start time;
receiving a parking termination request which include a parking end time;
determining a parking duration from the parking start time and the parking end time;
determining a parking fee according to the parking duration; and
charging the parking fee to a party identified within the parking authorization request.

3. The method of claim 2 further comprising:
providing information to parking enforcement personnel between the parking start time and the parking end time that a parking location identified by the parking authorization request is legitimately occupied.

4. The method of claim 3 further comprising:
providing information to parking enforcement personnel between the parking start time and the parking end time that a vehicle identified by the parking authorization request is legitimately parked.
